(19) United States
(12) Patent Application Publication
(10) Pub. No.: US 2014/0087088 A1
(43) Pub. Date: Mar. 27, 2014

(54) PROCESS FOR PRODUCING FOAMED WALLPAPERS

(71) Applicant: Henkel AG & Co. KGaA, Duesseldorf (DE)

(72) Inventors: Achim Schmitt, Leichlingen (DE); Daniel Wesemann, Porta Westfalica (DE); Thorsten Classen, Titz (DE); Mario Eckers, Wegberg (DE); Lothar Hendricks, Dorsten (DE); Hartmut Buesching, Port Westfalica (DE)

(21) Appl. No.: 14/088,562

(22) Filed: Nov. 25, 2013

Related U.S. Application Data
(63) Continuation of application No. PCT/EP2012/059096, filed on May 16, 2012.

(30) Foreign Application Priority Data
Jun. 1, 2011 (DE) 102011076862.9

(51) Int. Cl. C09D 131/04

(52) U.S. Cl. CPC C09D 131/04
USPC 427/542; 427/373; 427/271; 521/134

(57) ABSTRACT

The invention relates to a method for manufacturing a foamed coating on a web-shaped substrate, the substrate being coated entirely or partly with a coating agent, the applied coating being dried at a temperature above 70° C., and the coating agent being applied as a foam, an aqueous coating agent containing polymers selected from poly(meth)acrylates, maleinate polymers, or ethylene vinyl acetate polymers being used, and the coating agent being foamed by means of an introduced inert gas.

The invention relates to a method for applying coatings onto flexible web-shaped substrates that yield a foamed layer in the dried state. Also described is an aqueous coating agent that can be applied as a foam.

Foamed coated wallpapers are commonly known. In one manufacturing method, PVC layers are generated on a carrier substrate and the coating is then foamed using blowing agents. Foaming therefore takes place after layer formation. JP 56028933 describes a PVC paste that contains azodicarbonamide as a foaming agent. Such compositions can yield a foamed layer after being applied while hot.

NL7215102 describes multi-layer substrates that comprise as external layers a gel layer as well as an acrylate/PVC layer. The base layer is applied as a foamed layer made of crosslinking methylol acrylamide/PVC mixtures as polymers, and pigments.

Also known are coatings that are suitable for fire insulation, pigments that are not flammable and that foam up when heated being contained. JP 2006131779 describes a wallpaper that is made up of a support and an applied foam as a layer. The layer is manufactured from an aqueous EVA dispersion having 20% EVA, 0.5% additives, and 33% AlOH₃, as well as 5% TiO₂ as pigments.

EP 079723 describes a layer applied in foamed form, said layer being made up of latex dispersions. SBR polymers as well as natural latexes are described as a latex. These dispersions are foamed, and a gel is produced that is then applied. Selected substrates are used for the method. Latex polymers made of natural raw materials also contain low-molecular-weight constituents that represent allergenic substances. Additional care must therefore be taken when processing such binders, and also upon later use. The composition of such latexes is not described further.

Coatings for wallpapers which are based on acrylate polymers are known. Hollow microspheres are often used in this context to obtain a structure having cavities. Other compositions work with expandable hollow spheres that are contained in a layer and are applied, and the layer is then expanded and foamed by the application of heat.

Upon subsequent foaming of layers, it is difficult to always establish the same degree of foaming. An inhomogeneous layer thickness is obtained as a result. Further problems occur when PVC polymers are used. Firstly, these chlorine-containing polymers are environmentally critical; secondly, it is often necessary for these coated surfaces to be embossed at high temperature after foaming. The result is that only a weak embossing result is possible. A disadvantage of the microsphere-containing. compositions is the considerable price for obtaining a sufficient volume of regions in the layer that appear foamed. A further problem that results with heavy or very light pigments is the extent to which such coating agents can be stored without phase separation prior to application.

The object of the present invention is therefore to furnish a coating agent that can be applied as an aqueous coating agent in the form of a foam, the applied coating continuing to exhibit a foam structure after drying. A further object is to furnish a method for coating flexible web-shaped substrates, an aqueous foamed coating agent being applied onto said substrates and the coating being dried and crosslinked with retention of the foam structure. Those polymers which might give rise to objections in terms of health in the context of production and use are to be avoided.

The invention is achieved by a method for manufacturing a foamed coating on a web-shaped substrate, the substrate being coated entirely or partly with a coating agent, the applied coating being dried at a temperature above 70° C., wherein the coating agent is applied as a foam, an aqueous coating agent containing polymers selected from poly(meth)acrylates, maleinate polymers, or ethylene-vinyl acetate polymers being used, and the coating agent being foamed by means of an introduced inert gas.

A further subject of the invention is a coating agent that is furnished as an aqueous dispersion that is free of chlorine-containing polymers, where the coating agent is foamable with gases such as carbon dioxide, nitrogen, or air, and can be dried with retention of the foam structure.

In the method according to the present invention, a coating agent is applied in a continuous process as a foam onto a flat, flexible substrate, and then solidified as a foam. The known web-shaped substrates that can be used, for example, for adhesive bonding onto other objects can be used as a substrate. These can be, for example, wallpapers or other substrates that are suitable as wallpapers. They can be, in particular, flexible, thin, generally rollable substrates made of a variety of materials. Paper, nonwoven substrates, or also films or foils are particularly suitable. It is possible for the substrates to have one layer or multiple layers. These substrates serve as carriers for the subsequently coated webs, and impart to the coated objects the necessary mechanical stability in the context of manufacture and utilization, for example as a wallpaper. Substrates that are permeable to moisture are particularly suitable. This can involve, for example, fibers made of hydrophilic polymers, such as polyester fibers, or those made of natural raw materials such as cellulose. Single- or multiple-layer substrates of this kind based on nonwovens or paper are known.

The suitable coating agents for the method are aqueous. These are dispersions, emulsions, or solutions having water as a principal solvent, the term “dispersions” being intended hereinafter to encompass all different forms. These contain, as solids, polymers, emulsifier agents and/or surfactants, pigments, fillers, and/or dyes, as well as optionally further additives. Small proportions of organic solvents can also be contained. The polymers can be nonreactive, but crosslinking systems can also be involved.

The polymers are intended to be free of halogen-containing constituents, such as e.g. PVC as a polymer. Polymers based on poly(meth)acrylates, maleic acid copolymers, such as maleinate oils, polybutadiene oils, polyvinyl acetate copolymers such as EVA, are suitable. They can be homopolymers, copolymers, or mixtures of different polymers.

One example of polymers suitable according to the present invention is (co)polymerizates of olefinically unsaturated monomers. Suitable in particular in this context are independently water-insoluble (co)polymers that are obtainable by radical polymerization of unsaturated monomers, such as e.g. vinyl ester polymers as homopolymers or copolymers, polyacrylic acid esters or polymethacrylic acid esters, or copolymers with further polymerizable monomers containing double bonds.

Examples of polyacrylates are those that occur as a result of copolymerization of at least one (meth)acrylate monomer. Polar or nonpolar monomers can be selected; the monomers can also comprise further functional groups. Further copolymerizable monomers can also be added. The molecular weight, glass transition temperature, degree of crosslinking, hydrophobicity, or solubility can be influenced by the selection of monomers.

Suitable monomers are (meth)acrylate esters, such as e.g. alkyl (meth)acrylates of straight-chain, branched, or cycloaliphatic alcohols having 1 to 40 carbon atoms, such as e.g. methyl (meth)acrylate, ethyl (meth)acrylate, n-butyl (meth)acrylate, 2-ethylhexyl (meth)acrylate, stearyl (meth)acrylate, lauryl (meth)acrylate, cyclohexyl (meth)acrylate, aryl (meth)acrylates such as e.g. benzyl (meth)acrylate or phenyl (meth)acrylate, mono(meth)acrylates of ethers, polyethylene glycols, polypropylene glycols, or mixtures thereof having 5 to 80 carbon atoms, such as e.g. furfuryl methacrylate, 2-butoxyethyl methacrylate, poly(ethylene glycol) methyl ether (meth)acrylate, and poly(propylene glycol) methyl ether (meth)acrylate. Hydroxy-functionalized (meth)acrylates can also be contained, for example hydroxyalkyl (meth)acrylates of straight-chain, branched, or cycloaliphatic diols having 2 to 36 carbon atoms, such as e.g. 3-hydroxypropyl (meth)acrylate, 3,4-dihydroxybutyl mono(meth)acrylate, 2-hydroxyethyl (meth)acrylate, 4-hydroxybutyl (meth)acrylate.

In addition to the (meth)acrylates presented above, the compositions to be polymerized can also comprise further unsaturated monomers that are copolymerizable with the aforementioned (meth)acrylates. These include, among others, acrylonitrile, vinyl esters such as e.g. vinyl acetate, styrene, substituted styrenes such as α-methylstyrene, vinyl toluene, and p-methylstyrene, heterocyclic compounds such as 2-vinylpyridine, 3-vinylpyridine, vinyloxolane, vinylfuran, maleic acid derivatives such as e.g. maleic acid anhydride, maleinimide, methylmaleinimide, and dienes such as divinylbenzene, olefins such as ethylene, butadiene, chlorobutadiene, and isoprene, and comparable olefins having no further functionality, 1-alkenes such as 1-hexene, branched alkenes such as e.g. vinylcyclohexane, itaconic acid, crotonic acid, maleic acid, fumaric acid, or semiesters thereof, (meth)acrylic acid, acrylamide, methacrylamide, epoxy acrylates, or those having other functional groups.

Polyvinyl esters are a further group of suitable binders. These can be manufactured, for example, directly as a dispersion or emulsion. According to the present invention, the monomers contained are to be predominantly vinyl esters, as well as optionally portions of polymerizable monomers that carry functional groups, for example carboxyl groups, convertible into anionic groups, portions of nonpolar copolymerizable monomers such as aromatic monomers or unsaturated carboxylic acid esters, or portions of monomers that carry polar groups.

The copolymer is constructed from a variety of copolymerizable monomers. Components contained are in particular esters of vinyl alcohol and C2 to C8 monocarboxylic acids, for example vinyl acetate, vinyl propionate, vinyl n-butyrate.

Such polymers can additionally also contain copolymerizable monomers that contain acid groups as further functional groups. These can be inorganic acid groups such as sulfonic acid, phosphoric acid, or phosphoric acid groups, or preferably carboxylic acid groups. Such monomers assist dispersion in water.

Maleinate polymers are another class of suitable polymers. These are reaction products of drying oils and olefinically unsaturated carboxylic acids, particularly dicarboxylic acids, such as fumaric acid, maleic acid, and anhydrides thereof. The oils used are preferably drying and semi-drying oils such linseed oil, tall oil, rapeseed oil, sunflower oil, and cottonseed oil. The unsaturated carboxylic acids are selected so that under the usual conditions, after the addition of initiators and/or after heating, they graft radically onto the oils with high yield. Particularly suitable compounds are maleic acid, tetrahydrophthalic acid, acrylic and methacrylic acid, as well as citraconic, mesaconic, and itaconic acid, as an acid or in the form of its anhydride.

Fatty acids or fatty acid mixtures grafted to the aforesaid unsaturated acids are likewise suitable polymers. The suitable fatty acids comprise at least one olefinic double bond in the molecule; for example, oleic acid, linoleic and linolenic acid, ricinoleic acid, and elaidic acid, as well as the corresponding industrial mixtures of such acids, can be used.

Polydiene oils are likewise suitable. These are commercially usual products familiar to one skilled in the art. Mixtures of such polybutadiene oils having various molar masses or different configurations, e.g. including polypentadiene oils, can also be used.

The polymers can be nonreactive, but it is also possible to use polymers that subsequently crosslink, for example by oxidative crosslinking. The various polymers, such as polyacrylates, maleinate oils, polybutadiene oils, vinyl acetate copolymers, are in principle obtainable commercially in various forms. They can be selected on the basis of molecular weight, crosslinking groups, polarity, hydrophobic properties, or dispersibility.

The quantity of polymers is to be between 15 and 60 wt %, based on the coating agent. The coating agent can contain further additives in addition to the polymers and water. The quantity can be up to 100%, based on the quantity of polymers. Included among the additives are, for example, stabilizers, antioxidants, photostabilizers, wetting agents, pH regulators, plasticizers, pigments, fillers, dyes, catalysts, and the like. Adjuvants can also be added in order to meet special needs, for example odor compounds or biocides.

The coating agent according to the present invention is intended to contain at least one surface-active substance. These are understood as substances that influence surface tension, such as foam stabilizers, surfactants, or wetting agents. Such substances as a rule comprise hydrophilic and hydrophobic groups. A portion of the surface-active substances can already be added in the context of manufacture of the polymer dispersion, or they are incorporated only into the coating agent. They serve to control the foam, improve wetting, and stabilize those portions of monomers, polymers, or additives, optionally also pigments or fillers, which are not themselves water-soluble. Anionic, nonionic, ampholytic surfactants, or mixtures thereof can be contained.

Examples of suitable anionic surfactants are alkyl sulfates, alkyl and alkylaryl ether sulfates, such as alkylphenol ether sulfates; sulfonates, in particular fatty alcohol sulfonates, alkyl sulfonates, alkylaryl sulfonates; esters and semiesters of sulfosuccinic acid, which optionally can be ethoxylated; alkali and ammonium salts of carboxylic acids, for example of fatty acids; phosphoric acid partial esters, and alkali and ammonium salts thereof.

Examples of ampholytic surfactants are long-chain-substituted amino acids such as N-alkyldi(aminoethyl)glycine or N-alkyl-2-aminopropionic add salts, betaines, such as N-(3-acylamidopropyl)-N,N-dimethylammonium salts, or alkylimidazolium betaines.

Examples of nonionic surfactants are alkyl, alkylaryl, fatty alcohol polyglycol ethers; block copolymers, fatty alcohols, and alkylphenol adducts of ethylene oxide/propylene oxide (EO/PO), by preference those having approximately 8 to approximately 50 EO/PO units; addition products of alkylamines, fatty acids and resin acids, alkylpolyglycosides with linear or branched, saturated or unsaturated alkyl residues having 8 to approximately 24 carbon atoms and an oligopolyglycoside residue; natural substances and derivatives thereof, such as lecithin, lanolin, or sarcosine; in particular those having alkoxy groups having up to 10 carbon atoms and up to approximately 30 EO or PO groups.

In a preferred embodiment of the invention, the coating agent contains at least one surface-active substance. The coating agent according to the present invention can contain, for example, anionic or a nonionic surfactant in a quantity from 0.01 to approximately 5.0 wt %, for example from 0.1 to 2.5 wt %, based on the total dispersion.

In a preferred embodiment, the coating agent is free of defoamers. These are to be understood as substances that disrupt the stability of bubbles and thus disrupt foam formation. They generally result in a lowering of surface tension when they are added to an aqueous dispersion. Such substances are based on silicone-containing or fluorine-based compounds or on liquid and/or viscous hydrocarbons. These substance classes are known to one skilled in the art and are commercially obtainable as defoamers. These coating agent according to the present invention is intended to be free of such substances.

As preservatives, it is advantageous to add benzoates, fluorides such as sodium fluoride, amidic substances, and hydroxybenzoic acid esters, in quantities from 0.1 to 2 wt %. As further additives the adhesive dispersion according to the present invention can contain up to 2 wt %, by preference 0.1 to 1 wt % light stabilizers. The so-called HALS compounds are particularly suitable as UV stabilizers.

Plasticizers are a further component of the coating agent according to the present invention. These plasticizers are used by preference to adjust the viscosity and flexibility, and are contained in general at a concentration from 0 to 20 wt %, by preference up to 10 wt %, in particular less than 2 wt %. Suitable plasticizers are, for example, medicinal white mineral oils, naphthenic mineral oils, polypropylene oligomers, polybutene oligomers, polyisoprene oligomers, hydrogenated polyisoprene and/or polybutadiene oligomers, benzoate esters, phthalates, adipates, vegetable or animal oils, and derivatives thereof. Hydrogenated plasticizers are selected, for example, from the group of paraffinic hydrocarbon oils. Polypropylene glycol and polybutylene glycol, as well as polymethylene glycol, are also suitable. Esters can also be used as plasticizers, for example liquid polyesters and glycerol esters, or plasticizers based on aromatic dicarboxylic acid esters. Organic solvents are preferably not to be contained.

It is also possible for portions of pigments and/or fillers, for example including as a color paste, to be contained. The quantity of such constituents is to be less than 30 wt %, preferably from 5 to 20 wt %. Another embodiment contains only less than 5 wt % of such fillers and pigments. “Pigments” and “fillers” are to be understood as inorganic powdered substances. These are, for example, oxides, phosphates, sulfates, or carbonates of aluminum, silicone, zirconium, titanium, zinc, iron, manganese or the alkali or alkaline earth metals. Examples thereof are calcium carbonate, titanium dioxide, zinc oxide, iron oxide, magnesium oxide, aluminum oxide, barium sulfate, silicon dioxide. Laminar pigments or flake-shaped metallic effect pigments are also suitable, for example aluminum oxides, aluminum silicate, magnesium silicate, and mixed silicates; graphite, metal pigments, coated mica. These are commercially obtainable. These can be used individually or as a mixture, or they are used with portions of organic dyes. These constituents can color the dried layer; they can produce visual effects, or they can also influence the viscosity and thixotropic behavior of the aqueous coating agent. If no pigments are used, transparent coatings can also be produced.

Resins can also be optionally contained. These can be natural resins or synthetic resins. Resins containing OH groups can also be used.

The coating agent according to the present invention is intended to be foamable by means of an introduced inert gas. It can therefore in particular be substantially free of expanded or expandable hollow microspheres, and is also intended to contain no gas-evolving foam forming agents, for example nitrogen-forming azo compounds or isocyanates. Volatile organic solvents are likewise to be contained only in small quantities; in particular, the coating agent is intended to be substantially free of organic solvents that evaporate at up to 100° C.

The coating agent can be manufactured from the constituents using methods known per se. The polymer is often manufactured as an aqueous dispersion. The further constituents can then be dispersed into this dispersion. With regard to the pigments and fillers, good distribution must be ensured so that the coating agent is shelf-stable. The coating agent is intended to have a solids content from 30 to 70 wt % (DIN 53189 at 105° C.), resulting from the sum of the individual constituents. The volatile constituents are in particular water. The pH can be adjusted by adding neutralizing agents. It can be, for example, between pH 5 and 9.

The density of the coating agent is from approximately 1.0 to 1.7 g/cm³ (density determined by pycnometer). It also depends on the nature and quantity of the pigments. The coating agent suitable according to the present invention is intended to have a viscosity from 500 to 10,000 mPas, preferably from 1000 to 8000, measured at approx. 25° C. (Brookfield, EN ISO 2555, measured at appropriate temperature).

A foam is produced from the suitable aqueous coating agents. This can be done using known apparatuses that enable the foaming of liquid compositions. In this context, a gas, in particular nitrogen, air, or CO₂, is introduced into the aqueous coating agent according to the present invention. The formation of the foam can be influenced by the quantity of gas, the distribution of the gas in the liquid, and the recirculation of the liquid. The foam is stable, i.e. even after leaving the apparatus for foaming, the foam remains stable and loses only a little volume. Suitable gases thereby become dispersed as foaming agents in the liquid. This can be carried out using mixing units, by injection, or also by dissolution in a liquid and subsequent depressurization. Apparatuses and methods for producing foams are known.

It is useful for the foam to decrease the density of the coating agent to less than approx. 80% of the initial value, preferably to less than 65%. The foam can have, in particular, a density of less than 0.80 g/cm³, in particular less than 0.6 g/cm³, particularly preferably less than 0.5 g/cm³. The bubbles of the foam are so small that the foam is seen visually substantially as a surface. In particular, the foam bubbles are to have a diameter of less than 1 mm, in particular less than 0.5 mm, particularly preferably less than 0.2 mm.

The nature and quantity of the foam can be influenced by the composition of the coating agent. The foam size can be influenced by the quantity and selection of the emulsifier agents. The foaming method itself with which the gas is introduced into the liquid can furthermore influence the foam properties. The ratio of foaming agent to gas can be adjusted, for example, from 0.8:0.2 to 0.2:0.8. The quantity, size, and distribution of the bubbles are in particular to be correspondingly influenced thereby. Smaller bubbles, and a uniform distribution of the bubbles in the foam, are preferred.

The foam is stable for a processing time period. Individual bubbles may collapse, accompanied by an individual change in density and in foam structure, but the foam as a whole remains stable over the processing time period. It is necessary according to the present invention for the foam to retain its structure even upon drying.

For the method according to the present invention, the substrates are to be furnished as a flat web. Onto this web a foam is applied in a continuous method. Application can occur using rolls, rollers, nozzles, a screen, or by flexo printing, or using a so-called air brush. Care must be taken that the application method enables continuous, planar application of the foam onto the substrate. The foam layer is smoothed immediately after application. It is thereby possible to ensure that a homogeneous foam layer of uniform thickness is generated on the substrate.

Immediately subsequent thereto, the substrate coated with the aqueous foam is further processed using a drying oven. Heating of the coated substrate takes place in the drying oven. Heating causes water to be removed from the substrate and from the coating. In addition, other volatile constituents that may optionally be necessary for manufacture of the coating composition according to the present invention are also driven off. This drying can be carried out by heating by convection with hot air, or by irradiation using IR radiators. Recirculation of the air to remove the emerging moisture accelerates the drying process. The temperature in the context of the drying step is intended to be from 70 to 220° C. It is selected so that rapid drying can be obtained. On the other hand, it must be ensured that the drying temperature does not thermally destroy the coating composition or the substrate. It is therefore preferred that the drying temperature be between 80 and 180° C. If a higher temperature is selected, the dwell time is shorter. The drying time can be from 1 second to 60 seconds, in particular from 2 to 30 seconds. If a low temperature is selected, the dwell time of the coated substrate in the drying oven can be longer. A dry and flexible substrate equipped with a foam layer is obtained by means of the method according to the present invention.

This substrate can be further processed in a variety of ways. On the one hand it is possible to roll up and store this substrate. Another processing form forwards the substrate directly thereafter to further processing. The surface can be imprinted, an embossing operation can take place, a further coating step can be performed, individually or also in combination. The coated substrate is then packaged, i.e. cut into suitable lengths and then converted into a storable form, for example by being rolled up, or by stacking sheet-shaped substrates. After the procedure according to the present invention the operation of embossing the dried coating can be performed after cooling to a temperature below 100° C., for example by so-called cold embossing. The layers are then dry and non-tacky, and can be further processed.

A further subject of the invention is an object manufactured in accordance with the method according to the present invention. This refers, for example, to web-shaped flexible substrates provided with a foam layer. The substrate is preferably intended to be made of nonwoven materials, for example cellulose fibers or other organic fibers. Other substrates are also possible, for example paper webs or plastic films in web form. The substrate is intended to have a thickness from 0.1 to approx. 2 mm. On this substrate a coating is produced from an aqueous coating agent applied in foam form. A foamed, elastic, and solid coating is applied onto this carrier substrate. This coating is intended to have a thickness from 0.1 to 3 mm. The density of the dried coating is, for example, less than 0.80 g/cm³. The coating is dry, it is not tacky, and it forms a stable, flexible foam. A corresponding substrate can be rolled up without destroying the foam layer.

The foam is made up only of the dried or foamed coating agent. It is not necessary and preferred that no foamed gas-containing or gas-evolving pigments (microspheres) be present in the coating.

A substrate manufactured in accordance with the method according to the present invention comprises a flexible carrier material. This is equipped on one side with a homogeneous foam-shaped layer. In a preferred embodiment, the substrate is made of paper or nonwoven material based on cellulose-containing fiber material. The overall cost of the manufacturing method is reduced by the use of gases, in particular air, as a foaming agent. It is not necessary to add expensive foamed fillers to the coating.

A further subject of the invention is the use of a substrate manufactured in accordance with the method according to the present invention as wallpaper. The method according to the present invention is suitable in particular for manufacturing a wallpaper coating. In an embodiment, the substrate, the coating, and/or the surface of the coating can be colored or imprinted. Particularly suitably, the coating is entirely or partly embossed; cold embossing, in particular, can be carried out.

A further advantage of the invention is that the type of foam can be influenced by way of the selection of the aqueous coating agent resp. by way of the apparatus for introducing the gases into the coating agent. It is thus possible for the user to apply differently structured foams or foam layers of different thicknesses onto the substrate, The use of aqueous coating agents ensures that rapid and good drying is possible. No substances hazardous to health are released in the context of the processing operation. The coated product is likewise free of known substances hazardous to health or to the environment.

The substrates manufactured according to the present invention comprise a layer that can be further processed in additional steps in rapid and versatile fashion. Because gas-containing pigments are avoided, embossing can be carried out particularly easily. Mechanical stress on the embossing tools is decreased.

In addition, because of the selection of the binders, the coated substrates according to the present invention exhibit a good acceptance capability or adhesion for further colored coatings. Printing inks can be applied effectively, and result in an adherent printed image.

### EXAMPLE

A mixture of:

| | |
|---|---|
| Water | 51.5% |
| Polyvinyl acetate | 19.3 |
| Polyvinyl alcohol | 1.5 |
| PVOAc/PVOH copolymer | 7.5 |
| CaCO₃ | 20.0 |
| PEG-based surfactant | 0.1 |
| Aqueous base | 0.05 |
| Stabilizer | 0.05 |

is produced

The pigments are ground, and homogenized in the dispersed phase. The pH is adjusted to approx, 7.

Viscosity approx. 3500 mPas, 25° C. (EN ISO 2555, Brookfield viscosimeter).

The density is approx. 1.45 g/cm³.

The mixture is processed in a foam generator, using air as the gas, to yield a foam; ratio of coating agent to air=55:45.

From this foam, a layer 2 mm thick is produced with a doctor blade on a piece of paper (10×10 cm).

The layer is dried at 130° C. for 30 seconds in a recirculating air oven.

A paper substrate having a dried layer is obtained; layer thickness approx. 1.8 mm. The surface is not tacky, is soft, and can be embossed.

What is claimed is:

1. A method for manufacturing a foamed coating on a web-shaped substrate, the substrate being coated entirely or partly with a coating agent, the applied coating agent being dried at a temperature above 70° C., wherein the coating agent is applied as a foam, the coating agent being aqueous and containing polymers selected from poly(meth)acrylates, maleinate polymers, or ethylene-vinyl acetate polymers being used, and the coating agent being foamed by means of an introduced inert gas.

2. The method according to claim 1, wherein the foam is formed by the introduction of air, nitrogen, or CO₂ and mixtures thereof, as a gas, into the coating agent.

3. The method according to claim 1, wherein the coating agent achieves, by being foamed, a density of less than 0.80 g/cm³.

4. The method according to claim 1, wherein the coating has, after drying, a layer thickness from 0.1 to 3 mm.

5. The method according to claim 1, wherein drying is carried out by means of an IR radiator and/or with heated air, at a temperature above 80° C. for a time period of less than one minute.

6. The method according to claim 1, wherein after drying the coating is imprinted and/or embossed.

7. The method according to claim 1, wherein the substrate is constructed from hydrophilic polymers selected from polyester fibers and/or natural fibers.

8. An aqueous coating agent for use in a method according to claim 1, containing at least one polymer selected from poly(meth)acrylates, maleinate polymers, or ethylene vinyl acetate polymers, pigments and/or fillers, and further additives, wherein at least one surface-active substance is contained, and the coating agent is foamable by the introduction of air, nitrogen, carbon dioxide or mixtures, as a gas, into the coating agent.

9. The aqueous coating agent according to claim 8, wherein the coating agent is free of defoaming substances.

10. The aqueous coating agent according to claim 8 wherein the coating agent is free of silicone-containing, fluorine-based, or hydrocarbon-based defoamers.

11. The aqueous coating agent according to claim 8, wherein the coating agent has a solid content from 30 to 70 wt % and a viscosity from 500 to 10,000 mPas.

12. The aqueous coating agent according to claim 8, wherein the coating agent is free of expanded or expandable hollow microspheres and contains no gas-evolving foam-forming agents.

13. The aqueous coating agent according to claim 8, wherein the coating agent is present in gas-foamed fashion, and has a density of less than 80% of the initial density.
